(19) United States
(12) Patent Application Publication
(10) Pub. No.: US 2006/0190723 A1
(43) Pub. Date: Aug. 24, 2006

(54) Payload layer security for file transfer

(75) Inventor: Glenn S. Benson, Newton, MA (US)

Correspondence Address: DOCKET ADMINISTRATOR;LOWENSTEIN SANDLER PC, 65 LIVINGSTON AVENUE, ROSELAND, NJ, 07068, US

(73) Assignee: JP Morgan Chase Bank, New York, NY (US)

(21) Appl. No.: 11/206,352

(22) Filed: Aug. 18, 2005

Related U.S. Application Data
(60) Provisional application No. 60/654,642, filed on Feb. 18, 2005.

(51) Int. Cl. H04L 9/00

(52) U.S. Cl. 713/165

(57) ABSTRACT

A method for providing file transfer security includes receiving an authentication file including a first key and authentication information, extracting the first key from the authentication file, decrypting the authentication information with the first key, and validating the authentication information. The authentication information is encrypted, and may include a nonce, a timestamp, and/or a second key. A system for providing file transfer security includes a DMZ proxy programmed and configured to receive an authentication file from a client including authentication information. The DMZ proxy extracts a first key from the authentication file, decrypts the authentication information with the first key, and validates the authentication information.

### CROSS-REFERENCE TO RELATED APPLICATION

This application claims the benefit of U.S. Provisional Patent Application No. 60/654,642, filed Feb. 18, 2005, the entire disclosure of which is hereby incorporated herein by reference.

### FIELD OF THE INVENTION

The present invention relates generally to secure computer communication systems, and, more particularly, to methods and systems for providing secure file transfers between clients and servers via firewalls.

### BACKGROUND OF THE INVENTION

It is common for organizations today, such as, for example, corporations, schools, or other entities, to have a computer network, or intranet, to facilitate the sharing and processing of information amongst computers within the same organization. In addition to communicating with computers within an organization over an intranet, computers within an processing of information amongst computers within the same organization. In addition to communicating with computers within an organization over an intranet, computers within an organization often communicate and share information with computers external to the organization, typically via the Internet.

To protect computers within the organization from unauthorized access by external computers, organizations typically use a DMZ or a firewall. A DMZ, short for demilitarized zone, is a computer or small subnetwork that sits between a trusted internal network, such as an intranet, and an untrusted external network, such as the Internet, typically delimited by one or more firewalls. A DMZ separates an organization's resources from the outside, e.g., the Internet. A good security structure for the DMZ is the following: If the DMZ receives data from the outside, then the DMZ must authenticate and authorize the data before forwarding the data to one of the organization's computers.

With respect to computer security, authentication is the process by which a computer, computer program, or another user attempts to confirm that the computer, computer program, or user from whom the second party has received some communication is, or is not, the claimed first party. Authentication ensures that one party knows the identity of another party in a communication, while authorization ensures that a party may only access data if properly entitled. With such a security policy, no direct connection may exist between an outside resource and one of the organization's computers located on the organization's intranet. Rather, data must first pass through the DMZ for authentication and authorization.

Computer security defends a system against external attack. A common objective of computer security architecture is to define a system in which defense is efficient, and attack is inefficient. By way of example, the following exemplary system would generally not be considered to be a system in which defense is efficient, and attack is inefficient. In such a system, a client (attacker) builds a program which processes an infinite loop. The program uses the infinite loop to generate random data, and sends the data to a defended system under the guise of a file. This type of program is the type used in so-called denial of service (DoS), or replay attacks. The defended system receives the ‘file,’ and interprets the ‘file’ as being one that once resided on the client's system. In this example, the ‘file’ was created by the client's infinite loop program. In this example, both the client and the defended system utilize approximately equal network resources. However, the client requires relatively little data storage capacity, while the defended system consumes a relatively large amount of data storage capacity while receiving the ‘file.’ Such a system would generally be considered to encompass a relatively unfavorable security architecture because the client (attacker) requires fewer data storage resources than the defender. Therefore, the attacker is more efficient than the defender. The defender, in this case, would be vulnerable to denial of service attacks. As used herein, a file is an ordered sequence of bits.

As a general example of such a conventional security structure, with reference to FIG. 1, a client 101 sends data through a communication link 104 to a server via a DMZ proxy (FTP (File Transfer Protocol) firewall) 201. In this example, the FTP firewall 201 resides within the DMZ, and the server 102 is one of the organization's protected servers. The client 101 resides on the outside, external to the organization.

In this example, the client 101 sends information in blocks of ten 8-bit bytes. First, the client transmits three blocks of data 12 (i.e., 30 bytes and 240 bits). Next, an unauthenticated intruder interjects a fourth block of data 13. The FTP firewall 201 serves to safely proxy the first three blocks of data 12 to the server 102 over a communication link 202. However, the FTP firewall 201 should identify as problematic the fourth block of data 13, introduced by the intruder, and stop the connection.

While no DMZ proxy is always successful in preventing unauthorized intrusions, the security level of a DMZ proxy may be calculated in terms probabilities. In such a calculation, P is the probability that the DMZ proxy (FTP firewall 201) mistakenly authenticates or authorizes k bytes of a file, e.g., allows the fourth block of data 13 through to the server 102. A DMZ proxy provides good security if both P and k are relatively small. For example, a DMZ proxy provides good security if the probability that an attacker modifies ten bytes of a file (without detection in the DMZ) is less than one in a million. While perfect security is generally unobtainable, security to reasonable levels, within practical time and cost constraints, is what is preferred.

A file transfer mechanism moves a file of data between different computer systems. Different file transfer mechanisms are known to have differing levels of security (degree to which one may believe that the security system provides adequate security). For example, a popular standard for transferring files is described in RFC (Request For Comments) 959 (FTP). This standard describes file transfer with limited security.

When higher levels of security are sought, other standards address security issues by establishing a secure communication link independently with respect to the file transfer mechanism, e.g., SSL (Secure Sockets Layer) or SSH (Secure Shell). Such higher levels of security may be achieved by implementing file transfers via a secure channel by way of file transfer protocols such as RFC 2228 and SFTP (FTP through SSH), as is known to those skilled in the art. Such a secure communication link is general-purpose and may be used to securely transmit any kind of data. With such a link, with reference to FIG. 2, the client 101, uploads a payload file 103 to the server 102 over the communication link 104. Using a secure-communication-link method of security, the client 101 authenticates the communication link 104 by sending authentication credentials, e.g., a password or certificate-based authentication. Once a secure communication link is established, the client 101 uploads the payload 103.

The secure-communication-link method of security, however, has some deficiencies. For example, such a link does not differentiate the business payload (actual user-desired data files), and file transfer commands and other control commands. As a result, communication link cryptography does not provide “consequential evidence.” As used herein, “consequential evidence” and “non-repudiation” have the same definition. Non-repudiation is a property achieved through cryptographic methods which provides cryptographic evidence that an individual or entity performed a particular action related to data. The action cryptographically binds a unit of data to evidence that an individual or entity held a particular private key at the time that the cryptographic method was applied. As used herein, private keys used to provide consequential evidence are denoted with the naming prefix “d.” In the present context, consequential evidence asserts payload authentication and data integrity. For example, digital signatures have been used to provide non-repudiation, or consequential evidence.

Typically, a server must receive one hundred percent of a digitally signed payload before cryptographically validating the signature. Thus, if a relatively large file is being received, the time needed for downloading the entire file must elapse before validation may begin. A digital signature typically applies a private keying material in the signature operation, and a corresponding public keying material to validate the signature. As is known by those skilled in the art, a system can ensure the integrity of communicated information if a recipient of the information has assurance that he or she receives the same information that was transmitted by the sender. A mechanism may validate the integrity of communicated information by validating redundant information, such as, for example, a message digest. The sender transmits the information and the message digest to the recipient. The recipient re-computes the message digest and compares the re-computed message against the message digest obtained from the sender. If the respective message digests match, then the receiver has obtained validation of the integrity of the information. Not all message digests are secure. A message digest is cryptographically valid if it contains cryptographic properties which protect against the possibility of creating an inverse function. Exemplary cryptographically valid message digests are MD5, SHA1, and SHA256,a s are known to those skilled in then art. A digital signature is a mechanism which authenticates the sender, ensures integrity of the communicated data, and provides consequential evidence. A signature can be computed by executing a cryptographically valid message digest over information, and then executing an asymmetric cryptographic operation using a private key over the message digest. As a short hand notation, as used herein, signing with a private key is referenced as denoting an asymmetric cryptographic operation of using a private key over a message digest result. A keyed message digest mechanism is a message digest that has all the properties of an un-keyed message digest, as described above. In addition, a keyed message digest message has a key, such that it is cryptographically difficult to compute the keyed message digest result without knowing the required key. An example of a keyed message digest is HMAC (RFC 2104), as is known to those skilled in the art. HMAC can use keys of 128 bits or more in length. A mechanism has selectable entropy if one may use the mechanism with multiple different algorithms where the algorithms allow keys of different entropy, or with a single algorithm that allows keys of differing entropy (e.g., differing key lengths). For example, HMAC is a mechanism with selectable entropy.

As described in Menezes et. al., “Handbook of Applied Cryptography”, Boca Raton: CRC Press, 1997, p. 544. “A symmetric cryptographic system is a system involving two transformations—one for the originator and one for the recipient—both of which make use of either the same secret key (symmetric key) or two keys easily computed from each other.” A symmetric cryptographic algorithm is a specific algorithm supporting a symmetric cryptosystem.

As described in Menezes et. al., “Handbook of Applied Cryptography”, Boca Raton: CRC Press, 1997, p. 544, “An asymmetric cryptographic system is a system involving related transformations—one defined by a public key (the public key transformation), and another defined by a private key (the private transformation)—with the property that it is computationally infeasible to determine the private transformation from the public transformation.” An asymmetric cryptographic algorithm is a specific algorithm supporting an asymmetric cryptosystem. An asymmetric cryptographic operation is an execution of an asymmetric cryptographic algorithm. Some asymmetric cryptographic systems (e.g., RSA) permit one party to encrypt information using the second party's public key ensuring confidentiality between the sender and the recipient. Some asymmetric cryptographic systems, e.g., RSA, permit one party to digitally sign information; and another party to digitally validate the signature. The signing party applies the private key; and the validating party applies the corresponding public key.

Asymmetric cryptographic systems are often slower than symmetric cryptographic systems. This has resulted in asymmetric cryptographic systems not being widely used as a stand-alone cryptography system. However, asymmetric cryptographic systems are used in many hybrid cryptosystems such as PGP (RFC 1991), as is known to those skilled in the art. The basic principle of hybrid systems is to encrypt plaintext with a symmetric algorithm. The symmetric algorithm's key is then itself encrypted with a public-key algorithm such as RSA. The RSA-encrypted key and symmetric algorithm-encrypted message are then sent to the recipient, who uses his or her private RSA key to decrypt the symmetric algorithm's key, and then that key to decrypt the message.

An encoding method may be a keyless bi-directional transformation. For example, the hex encoding method can transform any 4 bits of data into one of 16 valid characters. The reverse transformation turns each of the 16 valid hex characters into the original 4 bits. The BASE64 encoding transforms any 6 bits of data into one of 64 valid BASE64 characters; and the inverse computes the original 6 bits. An example BASE64 transformation is provided in Section 4.3.2.4 of RFC 1421, as is known to those skilled in the art. An example of a slightly different transformation is Radix-64, as described in Section 2.4 of RFC 1991, as is known to those skilled in the art. In the Radix-64 transformation, a block, or segment, of data is transformed into BASE64-like characters as in the case of a BASE64 encoding. In addition, Radix-64 adds a checksum to each encoded block, or segment. In the reverse direction, the checksums are ignored, and the Radix-64 characters are transformed into the original 6 bits. One may check the validity of a keyless bidirectional encoding by ensuring that every character is within the allowable character set of the encoding, e.g., in BASE64 check that each character is either one of the permissible 64 characters or one of any additional, permissible control characters.

Another aspect of file transfer security is confidentiality. As used herein, confidentiality includes preserving authorized restrictions on information access and disclosure, including means for protecting personal privacy and proprietary information. A loss of confidentiality is the unauthorized disclosure of information.

Information theory measures the amount of information in a message by the average number of bits needed to encode all possible messages in an optimal encoding The entropy is a function of the probability distribution over the set of all possible messages. (See Denning at p. 17).

The deficiency or lack of consequential evidence of the above-discussed secure-communications-link security system, e.g., RFC 2228, can be overcome by, first, having the client digitally sign the payload (apply cryptographic operations at the payload layer), and, second, transmitting the signed payload through a secure communication link, as discussed above. Either or both parties may potentially authenticate the channel (i.e., perform channel authentication) to understand the identity of a peer that has access to the same channel. Payload authentication, on the other hand, establishes the identity of a data originator independently of the communication channel. For example, suppose Party A creates a file. If Party B obtains access to the file, then Party B may potentially use payload authentication to understand that Party A was the creator.

In accordance with the Open Systems Interconnection (OSI) seven-layer model, known to those skilled in the art, a networking system is divided into logical layers. Within each layer, one or more entities implement their functionality. Layer one, the physical layer, describes the physical properties of the various communications media, as well as the electrical properties and interpretation of the exchanged signals. Layer two, the data link layer, describes the logical organization of data bits transmitted on a particular medium. Layer three, the network layer, describes how a series of exchanges over various data links can deliver data between any two nodes in a network. The transport layer, layer four, describes the quality and nature of the data delivery. The fifth layer, the session layer, describes the organization of data sequences larger than the packets handled by lower layers. Layer six, the presentation layer, describes the syntax of data being transferred. Finally, layer seven, the application layer, describes how real work actually gets done, and provides different services to the applications.

This redundancy in applying cryptographic operations at both the payload layer and the communication link layer, however, has certain deficiencies. Such operations tend to be relatively time consuming and unwieldy, with relatively large file overhead for transmission, resulting in greater costs. Thus, there is a need for an improved method and system for a client to securely communicate a payload to a server.

### SUMMARY OF THE INVENTION

The present invention satisfies these and other needs by addressing security issues at the payload layer without requiring additional communications link security. Embodiments of the invention permit a client to securely communicate with a server indirectly via a DMZ Proxy (e.g., an FTP firewall).

In an embodiment of the present invention, when the client transmits Payload data, the DMZ Proxy validates the Payload data, a byte at a time, or a block at a time. The DMZ Proxy does not have to receive the entire file before beginning validation of the Payload data. Once the DMZ proxy validates and authenticates the Payload data, the Payload data is forwarded to the server. If the DMZ does not validate and authenticate the Payload data because, for example, the transmitted data has been tampered with by an intruder (hacker), file transmission can be stopped mid-stream. With this arrangement, the entire Payload file need not be received by the server prior to validation. Thus, the architecture facilitates satisfying the objective of ensuring that the attack is not more efficient than the defense.

In an embodiment of the present invention, the client uploads two files. The first file provides authentication and key management information, and the second file is a cryptographically processed Payload. The first file securely communicates a second key used to decrypt the second file.

In another embodiment of the present invention, a method for providing file transfer security includes receiving an authentication file including a first key (λ) and authentication information, extracting the first key (λ) from the authentication file, the first key being encrypted with public keying material, decrypting the authentication information with the first key (λ), and validating the authentication information.

According to an aspect of the embodiment, the authentication information is encrypted, and includes any or all of: a nonce (u), a timestamp (t), and a second key (k). Validating the authentication information includes validating a signature associated with the authentication information, and/or checking the nonce (u) and timestamp (t) pair for uniqueness.

According to another aspect of the embodiment, the method includes receiving a payload file associated with the authentication file. The payload file may be encoded by a known encoding method, such as, by way of a non-limiting example, BASE64 encoding. The method also includes decrypting and validating the payload file on a block-by-block basis, where a block, or segment, is one or more bytes. For example, if the payload is encrypted with a second key, the method includes decrypting the payload file with the second key.

According to yet another aspect of the embodiment, the method includes validating the decrypted payload on a block-by-block basis, and transmitting the payload file block-by-block after each block is validated. Alternatively, the payload file may be transmitted as a single block after all blocks of the payload file have been validated.

Another embodiment of the present invention is directed to a system for providing file transfer security. The system includes a DMZ proxy programmed and configured to receive an authentication file from a client including authentication information, to extract a first key from the authentication file, to decrypt the authentication information with the first key, and to validate the authentication information. In an aspect of the embodiment, the authentication information is encrypted and includes any or all of: a nonce, a timestamp, and a second key. Validating the authentication information includes validating a signature associated with the authentication information, and/or checking the nonce and timestamp pair for uniqueness.

According to an aspect of the embodiment, the DMZ proxy is programmed and configured to receive a payload file associated with the authentication file. The payload file is encrypted by a known encryption method, such as, by way of a non-limiting example, BASE64 encoding. The DMZ proxy also is programmed and configured to decrypt and validate the payload file on a block-by-block basis. For example, if the payload is encrypted with a second key, the DMZ proxy is programmed and configured to decrypt the payload file with the second key.

According to yet another aspect of the embodiment, the DMZ proxy is programmed and configured to validate the decrypted payload on a block-by-block basis, and to transmit the payload file block-by-block after each block is validated. Alternatively, the payload file may be transmitted as a single block after all blocks of the payload file have been validated.

Thus, embodiments of the present invention address the security issues at the payload layer without requiring additional communication-link security.

### BRIEF DESCRIPTION OF THE DRAWINGS

The present invention will be more readily understood from the detailed description of exemplary embodiments presented below considered in conjunction with the attached drawings, of which:

FIG. 1 illustrates a conventional communication arrangement wherein an unauthorized intruder attempts to interject a block of data;

FIG. 2 illustrates a traditional communication arrangement for providing file transfer security;

FIG. 3 illustrates an exemplary communication architecture, in accordance with an embodiment of the present invention;

FIG. 4 illustrates an exemplary file transmission work flow, in accordance with an embodiment of the present invention;

FIG. 5a is an exemplary schematic diagram of an asymmetric key structure, in accordance with an embodiment of the present invention;

FIG. 5b is an exemplary schematic diagram illustrating communicated values, in accordance with an embodiment of the present invention;

FIG. 6 is a flow diagram illustrating client-authentication processing of a payload, in accordance with an embodiment of the present invention;

FIG. 7 is an exemplary flow diagram illustrating DMZ Proxy authentication processing of a payload, in accordance with an embodiment of the present invention;

FIG. 8 is an exemplary flow diagram illustrating client processing of a payload, in accordance with an embodiment of the present invention;

FIG. 9 is an exemplary flow diagram illustrating DMZ Proxy processing of a payload, in accordance with an embodiment of the present invention; and

FIG. 10 is an exemplary flow diagram illustrating server processing of a payload, in accordance with an embodiment of the present invention.

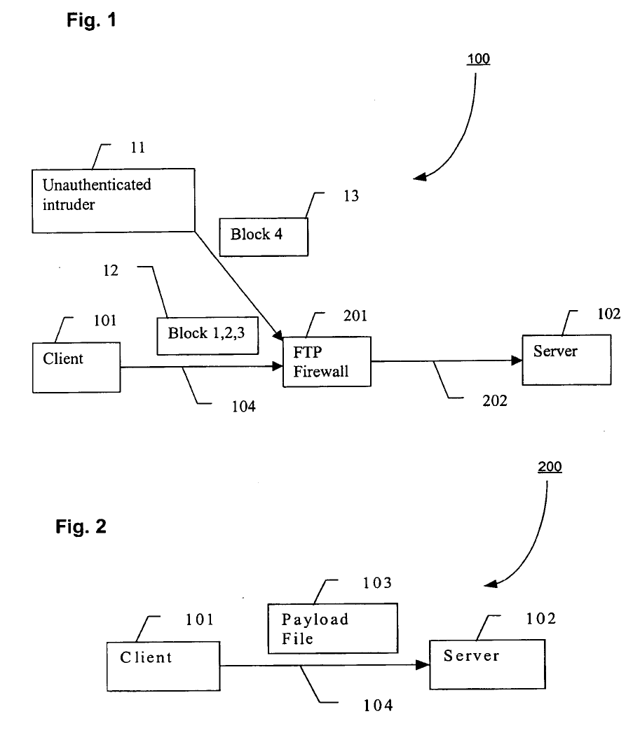

It is to be understood that the attached drawings are for purposes of illustrating the concepts of the invention and may not be to scale.

### DETAILED DESCRIPTION OF THE INVENTION

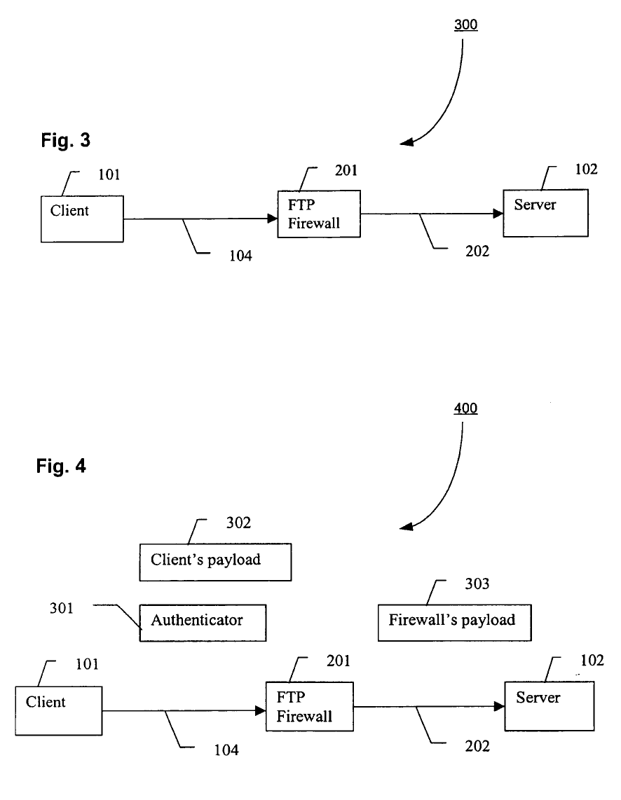

With reference to FIG. 3, there is shown a file communication architecture 300, in accordance with an embodiment of the present invention. The client 101 communicates with the server 102 indirectly via the FTP firewall 201, which is an example of a DMZ proxy. As used herein, the terms “FTP firewall” and “DMZ proxy” are used interchangeably. It is understood, however, by those skilled in the art, that a FTP firewall is one type of DMZ proxy, and that other firewall configurations may be used in accordance with the present invention. Thus, although embodiments of the present invention make use of FTP, one skilled in the art will appreciate that other protocols, either presently known, or later developed, may be used. The communication channel 104 connects the client 101 with the FTP firewall 201. The FTP firewall 201 makes mediation decisions, e.g., authentication and authorization. If the mediation decisions succeed, then the FTP firewall 201 may send information to the server 102.

With reference to FIG. 4, there is shown a file transmission work flow arrangement 400, in accordance with an embodiment of the present invention. The client 101 sends to the server 102 at least two files: 1) an authenticator (also referred to herein as the Authentication File) 301, which is a file used to authenticate the client 101 to the FTP firewall 201; and 2) a client processed payload (also referred to herein as the cryptographically processed payload) 302, which is a file used to transport the payload from the client 101 to the FTP firewall 201. Preferably, the client may send the files using FTP, which is readily available to clients free of cost. Such a use is contrary to conventionally-used file-security protocols, which typically require the use of relatively expensive and complex software. The FTP firewall sends to the server a FTP firewall-processed payload 303, which is a file used to transport the payload from the FTP firewall 201 to the server 102.

Certain aspects of the embodiment relate to the handling of the contents of the above-mentioned three files: 1) the authenticator 301; 2) the client-processed payload 302; and 3) the FTP firewall-processed payload 303. The following notations are used to describe the contents of the three files:

AA(x):=ASCII armor of literal data x. Without loss of generality, assume ASCII armor is a BASE64 encoding of the literal data x; however, other embodiments of the invention can use other encoding methods, as would be known to those skilled in the art.
x^{e}:=encrypt x with public key, e, using an asymmetric cryptographic algorithm With this notation convention, the first characters of asymmetric public keying material are an e-.
x^{d}:=sign x with private key, d, using an asymmetric cryptographic algorithm. With this notation convention, the first characters of asymmetric private keying material are a d-.
k{x}:=encrypt x with symmetric key, k, using a symmetric cryptographic algorithm.
u:=nonce (unique number).
t:=timestamp.
k:=random number used as a symmetric key.
λ:=unnamed random number used as a symmetric key.
(d-client 402,e-client):=client's asymmetric key pair, where d-client is confidential and resides at the client, and e-client is the corresponding public key (certificate).
(d-ftpfwall 404,e-ftpfwall 403):=DMZ proxy's (firewall's) key pair, where d-ftpfwall 403 resides at the ftpfirewall.
(d-server 406,e-server 405):=server's key pair, where d-server 406 resides at the server;
x:=payload file or literal data.

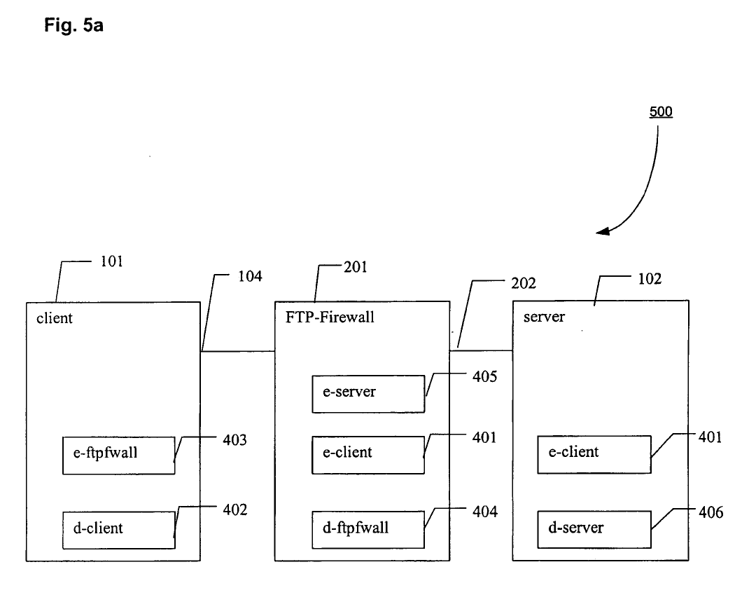

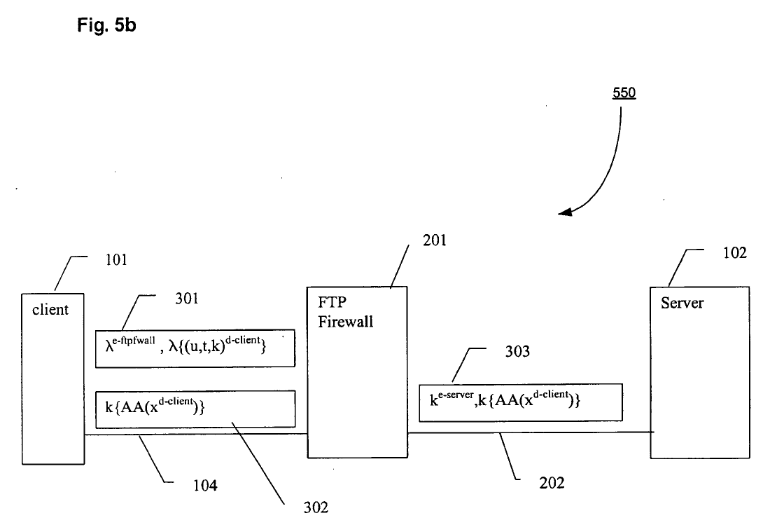

FIG. 5a illustrates the association 500 of key pairs with their respective computer systems. Specifically, d-client 402 and e-client 401 are the asymmetric key pair of the client 101, d-ftpfwall 404 and e-ftpfwall 403 are the key pair of the DMZ proxy (firewall) 201, and d-server 406 and e-server 405 are the key pair of the server 102.

FIG. 5b illustrates a schematic overview 550 of the communicated values, authenticator 301, client-processed payload 302, and FTP firewall-processed payload 303, and their respective relationships to client 101, FTP firewall 201, and server 102. The steps used to create these elements illustrated in FIGS. 5a and 5b are discussed in further detail below.

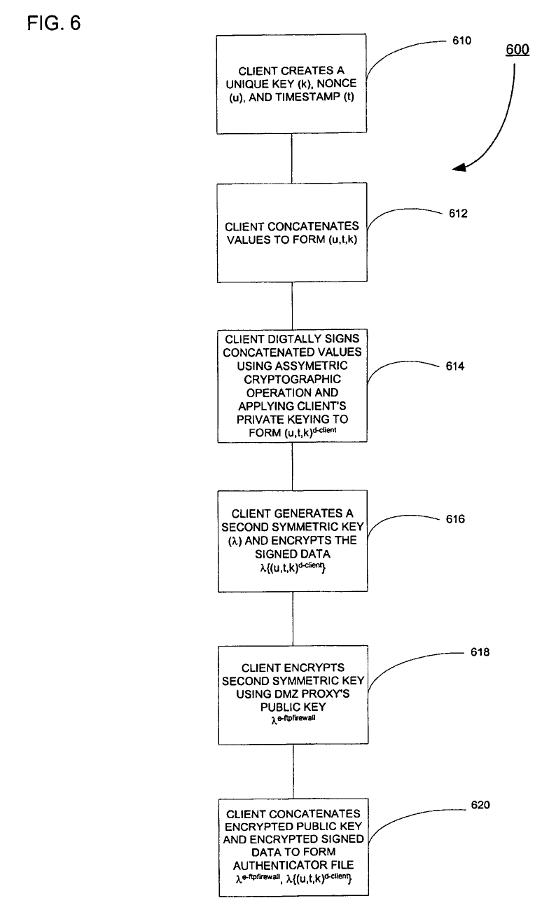

With reference to FIG. 6, there is shown a flow diagram illustrating a method 600 of client authentication-processing of a payload, in accordance with an embodiment of the present invention. In step 610, the client first creates a unique key k, and a nonce u, through a process which facilitates ensures unpredictability, e.g., secure pseudo-random number generated with a secure, confidential, random seed, or a random number generator. The client also gets the current timestamp, t. The client then, at step 612, concatenates these values to form (u,t,k) where the fields are delimited, by, for example, commas. Other techniques for delimiting the fields, such as by using XML notation, are within the scope of the present invention. Next, in step 614, the client digitally signs the concatenated values using an asymmetric cryptographic operation, e.g., RSA (Rivest, Shamir, and Adelman encryption), and applies the client's private keying material to form: (u,t,k)^{d-client}.

Next, at step 616, the client generates a second symmetric key, and uses λ in a symmetric encryption algorithm, e.g., 3DES (Triple DES), to encrypt the signed data, forming: λ{(u,t,k)^{d-client}}. For purposes of key management, the client encrypts λ using the FTP firewall's public key 403 to form: λ^{e-ftpfwall}, at step 618. Then, in step 620, the client concatenates this information to form the authenticator 301 file: λ^{e-ftpfwall}, λ{(u,t,k)^{d-client}}.

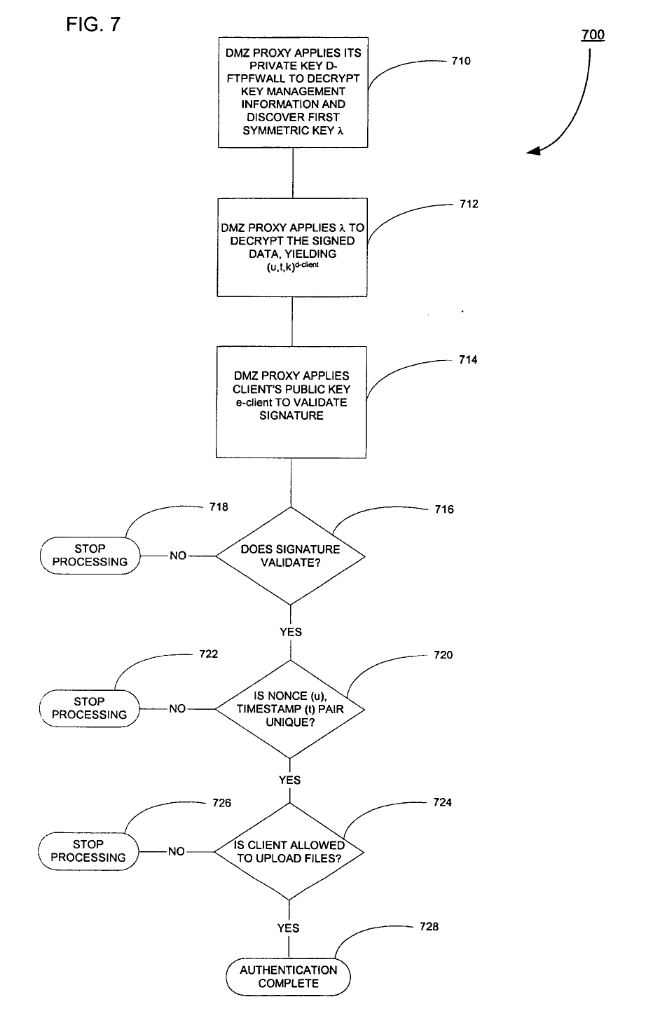

A flow diagram 700 illustrating DMZ proxy authentication processing of a payload, in accordance with an embodiment of the present invention, is illustrated in FIG. 7. First, the FTP firewall supplies its private key, d-ftpfwall 404, to decrypt the key management information to obtain λ, at step 710. Next, the FTP firewall applies λ to symmetrically decrypt the signed data to yield (u,t,k)^{d-client}}, at step 712. Next, at step 714, the FTP firewall applies the client's public key, e-client 401, to validate the signature. At step 716, if the signature does not validate, then the FTP firewall stops processing, at step 718. Thus, processing can stop before allowing receipt of any or all of the payload x. Otherwise, if the validation succeeds, then the FTP firewall checks the pair (nonce, timestamp) for uniqueness, at step 720. If the pair is not unique (i.e., if the FTP firewall has seen this pair at some time in the past), then the FTP firewall stops processing, at step 726. Otherwise, the FTP firewall performs authorization mediation, i.e., checks that the client is allowed to upload files, at step 724. If mediation fails, then processing of the file is terminated, at step 726. If mediation succeeds, then the FTP firewall has authenticated and authorized the client, at step 728. Optionally, instead of maintaining the history of all (nonce, timestamp) pairs, the server simply discards any timestamps received from the client that are too old by treating them as if they are not unique; and any timestamps that are too far in the future. The FTP firewall 201 may periodically discard any timestamps from its history list that it would discard if received from the client anyway. By way of example, the FTP firewall 201 could discard any authenticators 301 that contain timestamps where the date is more than two days in the past, or more than two dates in the future. For example, suppose that the FTP firewall 201 determines that the current date is the 50^{th} day of the year. If the FTP firewall 201 receives an incoming timestamp marked with the 48^{th}, 49^{th}, 50^{th}, 51^{st} or 52^{nd} day of the correct calendar year, then the FTP firewall 201 may accept the timestamp and compare with the history list. Otherwise, the FTP firewall 201 fails the timestamp check and stops in the stop processing step 722. At any time, on the 50^{th} day, the FTP firewall 201 may discard timestamps from its history list on the 47^{th} day or earlier. However, if the FTP firewall 201 accepts a timestamp from a valid day, then it must add to the history list. Subsequently, the server extracts the symmetric key, k, for use in the next step.

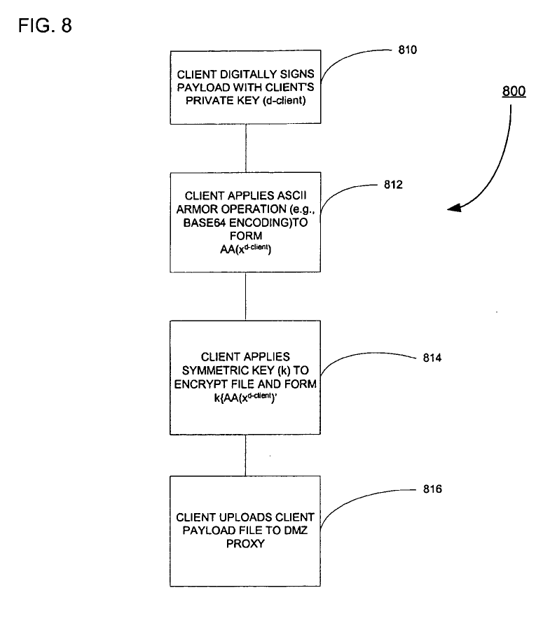

With reference to FIG. 8, there is shown, in accordance with another embodiment of the present invention, a flow diagram 800 illustrating client processing of a payload. In this embodiment, client processing of a payload is initiated by a script file. Alternatively, other methods of initialization may be used. First, the client digitally signs the payload with its private key, d-client 402, at step 810. Then, the client applies the ASCII armor operation (BASE64 encoding) to the result to form: AA(x^{d-client}), at step 812. Although in this exemplary embodiment, BASE64 encoding is employed, other encoding techniques (e.g., hexadecimal encoding), either currently used, or later developed, may be used, as would be applied by one of ordinary skill in the art, as informed by the present disclosure.

Next, the client applies the same symmetric key, k, used in the prior authentication step, to encrypt the file to form: k{AA(x^{d-client})}, at step 814. In step 816, the client uploads the client's payload file 302 to the FTP firewall 201. The client's payload file 302 has the value k{AA(x^{d-client})}.

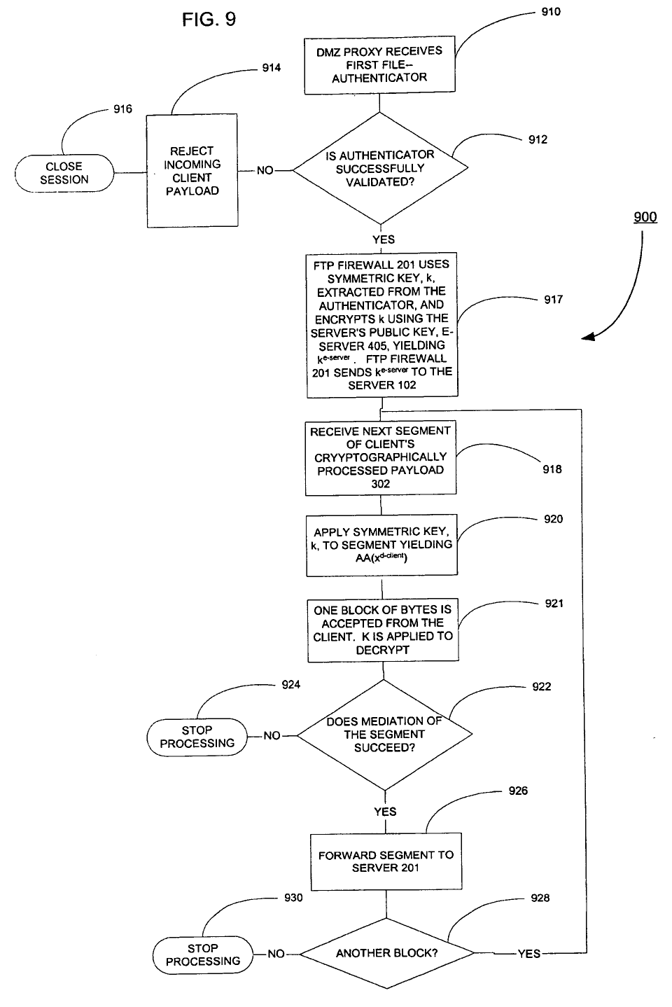

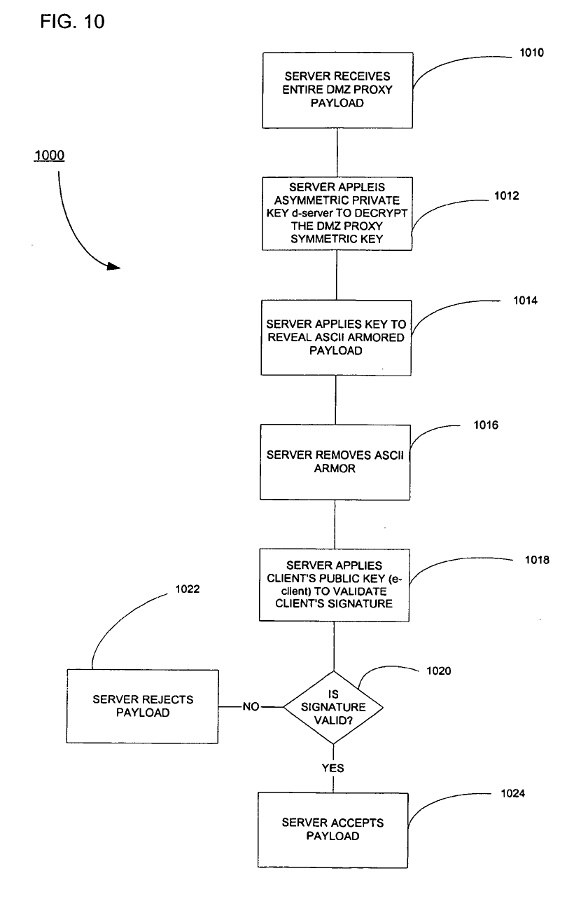

FIG. 9 is a flow diagram 900 illustrating FTP firewall's 201 processing of a payload, in accordance with an embodiment of the present invention. In this embodiment, the FTP firewall 201 functions to keep track of sessions. At step 910, the first received file in a session is the authenticator 301 file: λ^{e-ftpfwall}, λ{(u,t,k)^{d-client}} and is processed in accordance to the description in FIG. 7.

If any of the mediation decisions used to process the authenticator 301 fail, at step 912, then the FTP firewall 201 rejects an incoming client payload 302, at step 914, and closes the session, at step 916. At this point, the FTP firewall 201 discards the session symmetric key, k, extracted from the authenticator file 301. If, on the other hand, the mediation decisions of the authenticator 301 succeed, the FTP firewall 201 may continue processing. In step 917, the FTP firewall 201 uses the symmetric key, k, extracted from the authenticator, and encrypts k using the server's public key e-server 405 yielding k^{e-server}. The FTP Firewall 201 sends k^{e-server} to the server 102. The FTP Firewall 201 initiates a file communication to the server 102 by sending the first bytes of a file. These first bytes have the value k^{e-server}. The FTP Firewall 201 receives bytes of the client payload 302, at step 918. Then, the FTP firwall 201 uses the symmetric key, k, which it had previously extracted from the authenticator 301. By applying the symmetric key, k, to decrypt the subsequently received client payload 302, the FTP firewall 201 obtains AA(x^{d-client}), at step 920.

The FTP firewall 201 decrypts the client payload 302 on the fly. One block of bytes from the client is accepted, and k is applied to decrypt the accepted block, at step 921. That is, for each block of the client's payload 302 (a block is a sequence of one or more bytes where the number of bytes is established a priori on the FTP firewall through a local configuration parameter), the FTP firewall 201 performs the decryption operation. Assuming without loss of generality, that the encoding is BASE64, the FTP firewall 201 is configured to recognize that the result of the decryption is supposed to be BASE64 encoded. The FTP firewall 201 performs mediation on each of the decrypted bytes to determine whether each byte is from the 64 different possible allowable values. If the FTP firewall 201 encounters a block that decrypts to yield a byte from outside the space of 64 allowable values, at step 922, then the FTP firewall 201 stops processing immediately, at step 924.

If, on the other hand, the mediation by FTP firewall 201 on any particular block of information succeeds, at step 922, then the FTP firewall 201, at step 926, forwards the block to the server 102, and proceeds with the next byte, at step 928. In the present embodiment, the FTP firewall 201 processes the blocks in order. That is, if block i fails, then the FTP firewall 201 does not process block i+1. Therefore, the server 201 never sees block i+1 or any block of payload in the communication thereafter.

With respect to security, even though the unauthenticated intruder 11 does not know the value of the symmetric key, k, the unauthenticated intruder 11 can still potentially interject data. When the FTP firewall 201 subsequently applies k to a decryption operation, the result of the decryption of each byte is a random-appearing sequence. For example, assume each byte is an eight bit octet, each character is implemented in a single 8-bit byte, and BASE64 encoding yields 64 allowable characters (that is, 64 allowable bit sequences per byte). The probability that any decryption result of a byte happens to be a valid BASE64 symbol is one in four (¼). If a client 101 sends the client processed payload 302, and an attacker 11 were to interject his or her own bytes overwriting some of the bytes of the client processed payload, then the FTP Firewall 201 would receive a sequence of bytes where some were from the original client 101 and others were from the attacker 11. The client 101 does not divulge the payload key, k, to the attacker 11. In accordance with the description above, the probability that the attacker 11 substitutes j>0 bytes without detection by the FTP firewall 201 is (¼)^{j}. Some probabilities for corresponding values of j are listed in Table I, below:

TABLE I

| j | probability |
|---|---|
| j = 1 | 1/4 |
| j = 2 | 1/16 |
| j = 10 | 1/1,048,576 |
| j = 20 | 1/1.0995E+12 |
| j = 256 | 1/1.3408E+154 |

As is shown in Table I, the probability of receiving ten bytes interjected by the unauthenticated intruder 11 which happen to all decrypt to BASE64 symbols despite the fact that the intruder 11 does not know k, is less than one in a million (i.e., (¼)¹⁰=( 1/1,048,576)). The probability of receiving 256 bytes under the same conditions is approximately 1/(1.3408×10¹⁵⁴). In order to enhance the attacker's 11 probability of interjecting bytes without detection by the FTP firewall 201, the attacker would interject the fewest number of bytes. That is, if the attacker were to interject a single byte, then the probability would be ¼. In this case the server 102 would receive the payload 303 which contains a single interjected byte. Assuming that the interjected byte were different than the original, then the server's 102 signature validation in Step 1018 would fail, and the server 102 would reject the payload in Step 1022. Therefore, Step 1018 protects the server 102 from the possibility of accepting an incorrect payload; and the FTP firewall 201 detects the presence of an attacker's interjected byte(s) as soon as those bytes are received. In another embodiment, the probability of detecting an interjected byte at the FTP Firewall would increase if the client 101 were to use an ASCII Armor operation with greater redundancy. For example, if the ASCII Armor operation were to use BASE64 encoding into 16-bit characters, then the FTP Firewall 201 would inspect each 16-bit character for one of the valid 64 values. The probability that an attacker could interject a single character in this scenario without detection by the FTP firewall 201 would be 2⁶/2¹⁶= 1/1024. If the client 101 were to use BASE16 (hex) encoding into 8-bit characters, then the probability that an attacker could inject a single character without detection would be 1/16.

Table II, below, illustrates the probabilities for different values of j. The probability of detecting an error increases when either (i) the bits per character increase, or (ii) the BASE encoding decreases. Either of these methods, which increase the probability of detecting an error, also increase the size of the encoded file. For example, using BASE16 encoding, with 16 bits per character has a probability of mis-detecting an attack on a single character as 1/4096, and an attack on two characters as 1/16,777,216. However, every 4 bits of binary data expands into 16 bits of encoded data. The term “selectable entropy” means that the probability can be chosen by selecting the Base and character length of the encoding.

TABLE II

| | Probability | Probability | Probability | Probability |
|---|---|---|---|---|
| | with BASE | with BASE | with BASE | with BASE |
| | 64, 8 bits per | 16, 8 bits per | 64, 16 bits per | 16, 16 bits per |
| j | character | character | character | character |
| 1 | 1/4 | 1/16 | 1/1024 | 1/4096 |
| 2 | 1/16 | 1/256 | 1/1048576 | 1/16777216 |
| 3 | 1/64 | 1/4096 | 1/1.07E+09 | 1/6.87E+10 |
| 4 | 1/256 | 1/65536 | 1/1.1E+12 | 1/2.81E+14 |
| 5 | 1/1024 | 1/1048576 | 1/1.13E+15 | 1/1.15E+18 |
| 6 | 1/4096 | 1/16777216 | 1/1.15E+18 | 1/4.72E+21 |
| 7 | 1/16384 | 1/268435456 | 1/1.18E+21 | 1/1.93E+25 |
| 8 | 1/65536 | 1/4294967296 | 1/1.21E+24 | 1/7.92E+28 |
| 9 | 1/262144 | 1/68719476736 | 1/1.24E+27 | 1/3.25E+32 |
| 10 | 1/1048576 | 1/1.09951E+12 | 1/1.27E+30 | 1/1.33E+36 |
| 20 | 1/1.09951E+12 | 1/1.20893E+24 | 1/1.61E+60 | 1/1.77E+72 |

Although the FTP firewall 201 decrypts the client payload 302 as it receives the file, the purpose of the decryption is to check for correct BASE64 encoding. The FTP firewall 201 proxies the encrypted byte sequence: k{AA(x^{d-client})}. As used herein, a communication mechanism is connection-secure if a firewall does not forward information until it both authenticates the sender, and validates the received information for both authentication and integrity, before forwarding. The communication mechanism is connection-secure because the FTP Firewall 201 does not forward information to the server 102 until it both authenticates the sender (using the Authentication File 301), and validates the received information before forwarding through cryptographic means (see the probabilistic discussion above).

With reference to FIG. 10, there is shown a flow diagram 1000 illustrating server processing of a payload, in accordance with an embodiment of the present invention. The server begins this step after receiving the entire payload. If the server only receives partial payload because the FTP Firewall stopped forwarding, then aspects of the following process cryptographically fail and the server discard the payload. After receiving the firewall payload 303 in its entirety, at Step 1010, the server 102 applies its asymmetric private keying material, d-server 406, to decrypt k^{e-server} and obtain k, at Step 1012. Next, at Step 1014, the server 102 applies the decryption key k to k{AA(x^{d-client})} to obtain AA(x^{d-client})}. Next, at Step 1016, the server 102 removes the ASCII armor to obtain x^{d-client}. At this point, the server 102 applies the client's public keying material, e-client 401, to validate the client's signature at Step 1018. If the signature validates at Step 1020, then the server 102 accepts the payload x, at Step 1024. Otherwise, the server 102 rejects the payload x, at Step 1022.

In another embodiment of the invention the client does not sign the payload, and the server does not expect the payload to be signed. In this embodiment, the client and server skip the steps that sign and validate signatures using the client private key d-client, and the client's public key e-client, respectively. In yet another embodiment of the invention, the client sends authentication material other than the signed authentication file of the format specified in Authentication File 301. For example, the client sends the authenticator file λ^{e-ftpfwall}, λ{(u,t,k,auth)}, where “auth” is an authentication credential. By way of non-limiting example, such an authentication credential could be a password, or a one-time password as is employed by the protocol RFC 1760, as is known by those skilled in the art. In such an embodiment, when the server receives the authenticator file, the server validates the authentication credential before accepting the authenticator file. In yet another embodiment of the invention, the client does not send files, but, instead, sends other units of information such as messages or packets. In yet another embodiment, the client and server use an encoding method other than BASE64. The encoding method may potentially encode one byte at a time. For example, use of hex encoding could encode each 8-bit byte into two hex characters. Alternatively, the encoding may group multiple characters together in a single encoding operation. For example, the encoding could potentially transform 256 8-bit bytes into a sequence of 296 8-bit bytes where the first 256 8-bit bytes are identical to the original, and the final 40-bytes are extra redundancy information.

In certain embodiments discussed above, the client 101 sends one authentication file 301, which contains one key, k. The client 101 sends exactly one payload file 302 encrypted with key, k. In alternate embodiments, the authentication file 301 contains m keys, kl, . . . ,km. The user sends n payload files 302, fl, . . . ,fn, where each payload file 302 is encrypted with one of the m keys. Alternatively, multiple payload files could be encrypted with the same key. In an embodiment where m=n, each payload file gets its own, unique symmetric key.

Accordingly, the present invention provides a way to securely transmit any type of data, whether it be financial information, medical information, business information, personal information, or any other information that is desired to be transmitted securely. Therefore, costs associated with hacked or tampered data for a wide variety of industries is reduced. Further, the present invention provides secure data transmission without complex software operating on a client computer, thereby reducing costs and increasing customer satisfaction. Further still, embodiments of the invention facilitate the stopping of a file transmission mid-stream if the transmitted data has been tampered with. Therefore, entire files need not be received prior to validation, thereby reducing the negative effects of malicious data attacks, freeing up system resources affected by such malicious attacks, and reducing the financial costs associated with such attacks.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

An embodiment of the invention is File Transfer Connection Secure, which, as used herein, is defined as providing all of the following security properties:

Authentication of connection: The FTP Firewall 201 does not receive the secured payload 302 until after it validates the client's evidence of authentication, e.g., signature, of the authentication file 301.

Authentication of client: The FTP Firewall 201 authenticates the client, e.g., by applying the client's public keying material, e-client 401, to validate the signature of the authentication file 301, and the FTP-Firewall processed payload 303, respectively. The server 201 authenticates the client, e.g., applies the client's public keying material, e-client 401 to validate the signature of the FTP-Firewall processed payload 303.

Integrity: The Server 102 validates the integrity of the payload, e.g., by validating the signature of the FTP-Firewall processed payload 303.

Non-Repudiation/consequential evidence: The Server 102 logs material that may be used for non-repudiation/consequential evidence. For example, the FTP-Firewall processed payload 303 contains the payload signed by the client's private keying material, d-client 402. This signed payload when coupled with its respective validation provides non-repudiation.

Confidentiality: The Authentication File 301 is confidential and only seen by the client 101 and the FTP Firewall 201 and no other parties on the intermediary communication link. For example, the client 101 encrypts (u,t,k)^{d-client} with a symmetric key, k Only parties who know λ may view (u,t,k)^{d-client}. The client 101 encrypts λ using the FTP Firewall's 201 public key e-ftpfwall 403. Only the FTP Firewall 201 may decrypt to discover λ because only the FTP Firewall 201 knows the corresponding private key d-FTP Firewall 404.

The client 101 processes the payload x to produce AA(x^{d-client}). This value is encrypted with symmetric key, k, to produce k{AA(x^{d-client})}. As described above, only parties that know k can decrypt to find AA(x^{d-client}); and then further process to reveal x. As described above the client 101, or the FTP-Firewall 201 could potentially perform this operation because they know k. Also, the server 102 can perform this operation because the server 102 receives k^{e-server},k{AA(x^{d-client})}. The server 102 may apply its private key d-server to decrypt k^{e-server} to reveal k. Using the mechanism described above, the server 102 can further process to discover x. Parties other than the client 101, the FTP-Firewall 201, and the server 102 cannot discover x unless one of the parties either reveal to a third party information that should be kept confidential. Examples are private keying material (d-client, d-FTP-Firewall, d-server), symmetric keying material (k, λ), and the payload itself, x.

Connection integrity: The FTP-Firewall 201 drops a connection as soon as it detects an issue with a received byte. The FTP-Firewall 201 protects the communication link 202 by ensuring that it only forwards information which has been authenticated and authorized.

In one embodiment the client 101 communicates with the FTP Firewall 201 by sending the Authentication File 301, and the cryptographically processed payload 302 using the FTP Protocol (RFC 959), as is known to those skilled in the art. In another embodiment, the client 101 communicates with the FTP Firewall 201 by sending the Authentication File 301, and the cryptographically processed payload 302 using the POST method of the HTTP Protocol, as is known to those skilled in the art. In yet another embodiment, the client 101 communicates with the FTP Firewall 201 by writing the Authentication File 301, and the cryptographically processed payload 302 to a mobile non-volatile storage medium, then transporting the storage medium to the FTP Firewall 201. The FTP Firewall 201 accesses the non-volatile storage medium to read the files.

In yet another embodiment of the invention, the sender uses different protocols to transmit the authentication file 101 and the cryptographically secured payload 302. For example, the sender uses HTTP to send the authentication file, and FTP to send the cryptographically secured payload.

In another embodiment of this invention, the client 101 operates using the following sequence of events: 1) Client 101 opens a connection to the FTP Firewall 201; 2) Client 101 initiates transfer of (u,t,k); 3) Presentation layer of connection protocol cryptographically transforms (u,t,k) into an authentication file 301; 4) Client 101 initiates transfer of payload; 5) Presentation layer of connection protocol cryptographically transforms payload into the cryptographically processed payload file 302.

The FTP Firewall 201 and server 102 process in accordance with an earlier described embodiment of the invention, except that the cryptographic processing is performed at the presentation layer.

In another embodiment of the invention, the FTP Firewall 201 receives the entire cryptographically processed payload file 302 before transmitting any portion of the cryptographically processed payload file 302 to the server 102.

What is claimed is:

1. A method for providing file transfer security, the method comprising the steps of:
receiving an authentication file that includes decrypting information; and
receiving an encrypted payload file, the decrypting information being configured to facilitate decryption of the payload file.

2. The method of claim 1, comprising the step of decrypting the payload file by use of the decrypting information.

3. The method of claim 1, comprising the step of detecting an error in the payload file by way of cryptographically secure error detection method.

4. The method of claim 3, wherein a key is used to secure the error detection algorithm, the key having a selectable entropy.

5. The method of claim 3, wherein a key is used to secure the error detection algorithm, the key having entropy of at least 100 bits.

6. The method of claim 3, wherein a probability of an intruder, without the required keys, of defeating the method of securing the error detection is less than one in a million.

7. The method of claim 3, wherein the provided file transfer security is File Transfer Connection Secure.

8. The method of claim 1, wherein the encrypted payload file comprises two or more encrypted payload files.

9. A method for providing file transfer security, the method comprising the steps of:
receiving a payload file on a block-by-block basis;
if an error is present in a received block, detecting the error; and
upon detection of an error in a received block, terminating the receiving of the payload file
wherein the provided file transfer security is File Transfer Connection Secure.

10. The method of claim 9, wherein a key used to provide integrity, confidentiality, or non-repudiation/consequential evidence of File Transfer Connection Security has at least 100 bits in entropy.

11. The method of claim 9, wherein the probability of defeating the method of ensure integrity is less than one in a million for anyone who does not know the required keys.

12. The method of claim 9, wherein the mechanism for providing File Transfer Connection Secure file transfer security is received by way of an application layer protocol.

13. The method of claim 9, wherein the payload file is received by way of a presentation layer.

14. The method of claim 9, wherein the step of detecting an error is accomplished by way of an error detection algorithm that has a selectable entropy security.

15. The method of claim 14, wherein the step of detecting an error is accomplished by the way of an error detection algorithm that relies upon a key that has at least 100 bits of entropy.

16. The method of claim 9, wherein the payload file is sent by a client, the payload file being sent by a protocol that is selectable by the client.

17. The method of claim 16, wherein the client selects an RFC 959 protocol.

18. A method for providing file transfer security, the method comprising the steps of:
receiving an authentication file including a first key and authentication information, wherein the authentication file is associated with a payload file;
extracting the first key from the authentication file; and
decrypting the authentication information with the first key.

19. The method of claim 18, comprising the step of validating the authentication information and thereby authenticating the sender.

20. The method of claim 18, wherein the authentication information is encrypted.

21. The method of claim 18, wherein the authentication information includes a nonce, and a timestamp.

22. The method of claim 21, wherein the step of validating comprises validating a signature associated with the authentication information.

23. The method of claim 21, wherein the step of validating comprises checking a pair formed of the nonce and the timestamp for uniqueness.

24. The method of claim 21, wherein the step of validating comprises:
validating a signature associated with the authentication information; and
checking a pair formed of the nonce and the timestamp for uniqueness.

25. The method of claim 22, wherein the signature is a digital signature created using asymmetric public and private keying material.

26. The method of claim 21, further comprising the step of receiving the payload file associated with the authentication file.

27. The method of claim 26, wherein the payload file is encrypted.

28. The method of claim 26, wherein the payload file is encoded by a keyless bidirectional transformation whereby an encoding result is encrypted using a symmetric key.

29. The method of claim 27, further comprising decrypting and validating the payload file on a block-by-block basis by checking validity of the keyless bi-directional transformation after decrypting with the symmetric key.

30. The method of claim 26, the authentication file comprising a second key, wherein the payload is encrypted with the second key, and wherein the method further comprises the step of decrypting the payload file with the second key.

31. The method of claim 29, further comprising the step of validating the decrypted payload on a block-by-block basis.

32. The method of claim 31, further comprising the step of transmitting the payload file block-by-block after each block is validated.

33. The method of claim 31, further comprising the step of transmitting the payload file as a single block after all blocks of the payload file have been validated.

34. A connection-secure system for providing File Transfer Security in which a sender performs all cryptographic operations before transmitting any or all of a payload file to the recipient.

35. The method of claim 34, the method comprising the steps of:
a first phase whereby a client performs cryptographic processing operations; and
a second phase whereby the client transmits information to a recipient;
wherein the second phase does not initiate until the first phase is completed in its entirety.

36. The method of claim 35, wherein no cryptographic operations are performed during the second phase.

37. The method of claim 35, wherein no cryptographic operations upon the payload file are performed during the second phase.

38. The method of claim 35, wherein no cryptographic operations which apply symmetric key encryption upon the payload file are performed in the second phase.

39. The method of claim 35, wherein, when no symmetric key operations are performed during the second phase, the payload file is accurately transferred.

40. A system for providing file transfer security, the system comprising one or more processors configured to perform the steps of:
receiving an authentication file that includes decrypting information; and
receiving an encrypted payload file, the decrypting information being configured to facilitate decryption of the payload file.

41. The system of claim 40, the processors configured to perform the step of decrypting the payload file by use of the decrypting information.

42. The system of claim 40, the processors configured to perform the step of detecting an error in the payload file by way of cryptographically secure error detection method.

43. The system of claim 42, wherein a key is used to secure the error detection algorithm, the key having a selectable entropy.

44. The system of claim 42, wherein a key is used to secure the error detection algorithm, the key having entropy of at least 100 bits.

45. The system of claim 42, wherein a probability of an intruder, without the required keys, of defeating the system of securing the error detection is less than one in a million.

46. The system of claim 42, wherein the provided file transfer security is File Transfer Connection Secure.

47. The system claim 40, wherein the encrypted payload file comprises two or more encrypted payload files.

48. A system for providing file transfer security, the system comprising one or more processors configured to perform the steps of steps of:
receiving a payload file on a block-by-block basis;
if an error is present in a received block, detecting the error; and
upon detection of an error in a received block, terminating the receiving of the payload file
wherein the provided file transfer security is File Transfer Connection Secure.

49. The system of claim 48, wherein a key used to provide integrity, confidentiality, or non-repudiation/consequential evidence of File Transfer Connection Security has at least 100 bits in entropy.

50. The system of claim 49, wherein the probability of defeating the system of ensure integrity is less than one in a million for anyone who does not know the required keys.

51. The system of claim 49, wherein the mechanism for providing File Transfer Connection Secure file transfer security is received by way of an application layer protocol.

52. The system of claim 49, wherein the payload file is received by way of a presentation layer.

53. The system of claim 49, wherein the step of detecting an error is accomplished by way of an error detection algorithm that has a selectable entropy security.

54. The system of claim 53, wherein the step of detecting an error is accomplished by the way of an error detection algorithm that relies upon a key that has at least 100 bits of entropy.

55. The system of claim 49, wherein the payload file is sent by a client, the payload file being sent by a protocol that is selectable by the client.

56. The system of claim 55, wherein the client selects an RFC 959 protocol.

57. A system for providing file transfer security, the system comprising one or more processors configured to perform the steps of:
receiving an authentication file including a first key and authentication information, wherein the authentication file is associated with a payload file;
extracting the first key from the authentication file; and
decrypting the authentication information with the first key.

58. The system of claim 57, the processors configured to perform the step of validating the authentication information and thereby authenticating the sender.

59. The system of claim 57, wherein the authentication information is encrypted.

60. The system of claim 57, wherein the authentication information includes a nonce, and a timestamp.

61. The system of claim 60, wherein the step of validating comprises validating a signature associated with the authentication information.

62. The system of claim 60, wherein the step of validating comprises checking a pair formed of the nonce and the timestamp for uniqueness.

63. The system of claim 60, wherein the step of validating comprises:
validating a signature associated with the authentication information; and
checking a pair formed of the nonce and the timestamp for uniqueness.

64. The system of claim 63, wherein the signature is a digital signature created using asymmetric public and private keying material.

65. The system of claim 60, the processors further configured to perform the step of receiving the payload file associated with the authentication file.

66. The system of claim 64, wherein the payload file is encrypted.

67. The system of claim 64, wherein the payload file is encoded by a keyless bidirectional transformation whereby an encoding result is encrypted using a symmetric key.

68. The system of claim 66, the processors configured to perform the step of decrypting and validating the payload file on a block-by-block basis by checking validity of the keyless bi-directional transformation after decrypting with the symmetric key.

69. The system of claim 65, the authentication file comprising a second key, wherein the payload is encrypted with the second key, and wherein the processors configured to perform the step of decrypting the payload file with the second key.

70. The system of claim 68, the processors configured to perform the step of validating the decrypted payload on a block-by-block basis.

71. The system of claim 70, the processors configured to perform the step of transmitting the payload file block-by-block after each block is validated.

72. The system of claim 70, the processors configured to perform the step of transmitting the payload file as a single block after all blocks of the payload file have been validated.

73. A connection-secure system, comprising one or more processors, for providing File Transfer Security in which a sender performs all cryptographic operations before transmitting any or all of a payload file to the recipient.

74. The system of claim 73, the processors configured to perform the steps of:
a first phase whereby a client performs cryptographic processing operations; and
a second phase whereby the client transmits information to a recipient;
wherein the second phase does not initiate until the first phase is completed in its entirety.

75. The system of claim 74, wherein no cryptographic operations are performed during the second phase.

76. The system of claim 74, wherein no cryptographic operations upon the payload file are performed during the second phase.

77. The system of claim 74, wherein no cryptographic operations which apply symmetric key encryption upon the payload file are performed in the second phase.

78. The system of claim 74, wherein, when no symmetric key operations are performed during the second phase, the payload file is accurately transferred.

79. A method for providing file transfer security, the method comprising the steps of:
receiving an authentication file that includes decrypting information;
receiving an encrypted payload file, the decrypting information being configured to facilitate decryption of the payload file;
decrypting the payload file by use of the decrypting information; and
detecting an error in the payload file by way of cryptographically secure error detection method;
wherein a key is used to secure the error detection algorithm, the key having a selectable entropy.

80. A method for providing file transfer security, the method comprising the steps of:
receiving an authentication file including a first key and authentication information, wherein the authentication file is associated with a payload file;
extracting the first key from the authentication file;
decrypting the authentication information with the first key;
receiving a payload file associated with the authentication file;
the authentication file comprising a second key, wherein the payload is encrypted with the second key,
decrypting the payload file with the second key;
validating the decrypted payload on a block-by-block basis;
if an error is present in a received block, detecting the error; and
upon detection of an error in a received block, terminating the receiving of the payload file.
